(19) United States
(12) Patent Application Publication
(10) Pub. No.: US 2016/0208991 A9
(43) Pub. Date: Jul. 21, 2016

(54) Rotary Head Flashlight Headlamp

(71) Applicant: Mathew Inskeep, Highland Beach, FL (US)

(72) Inventor: Mathew Inskeep, Highland Beach, FL (US)

(21) Appl. No.: 14/454,902

(22) Filed: Aug. 8, 2014

Related U.S. Application Data
(60) Provisional application No. 61/875,884, filed on Sep. 10, 2013.

(51) Int. Cl. F21L 4/04

(52) U.S. Cl. CPC F21L 4/04; F21Y 2101/02

(57) ABSTRACT

A flashlight headlamp is described. The flashlight headlamp has a rotary illuminating head around the main shaft capable of forming a right angle upon illumination.

This application claims the benefit and priority of U.S. Ser. No. 61/875,884

### STATEMENT REGARDING FEDERALLY SPONSORED RESEARCH

The invention was not made under government contract nor was funded grant money used to fund the research

### FIELD

Portable Flashlight Headlamp

### BACKGROUND

The present invention relates to flashlight headlamp with a rotary illuminating head. This particular device contains a head that rotates around the main shaft forming a right angle upon rotation while illuminating during rotation. The head of this particular device contains within a high power light emitting diode to be utilized in dark areas as an illumination device.

### SUMMARY

The novelty of this invention, is having a flashlight headlamp with multiple angles of rotation with a high power light emitting diode to access difficult to see areas due to darkness or low light visibility. The rotating head have integral steps of rotation guides and stopper for a smooth transition between positions. The flashlight headlamp first position is when the rotary head is in-line with the main body at zero degree angle also called the shaft. During rotation of the rotating head, this particular tool provides several angles of rotation until reaching its complete and final position where the head becomes perpendicular to the shaft forming a ninety degree angle. Users can take advantage of the present invention by having a multi position flashlight.

### DRAWINGS

FIG. 1 is a complete view of the present invention that shows the main parts of the invention composed of the rotary head, the main body and the power switch.

FIG. 2 is a perspective view of the internal construction and mechanical operation of the rotating head lamp.

FIG. 3 is an exploded view of the complete unit with details of the internal components.

FIG. 4 is an exemplary view of a hands free bracket that could be also utilize to support the flashlight tool during operation.

### DETAILED DESCRIPTION

The present invention pertains to a new and improved flashlight headlamp with a ninety degree rotary head lamp also including associated powering controls. This particular device contains a head that rotates around the main shaft forming a right angle when turned. This device is also a complete light unit consisting of a high power light emitting diode used as the main lamp. The rotary head mechanism of the present invention forms a complete assembly when coupled to the main body shaft.

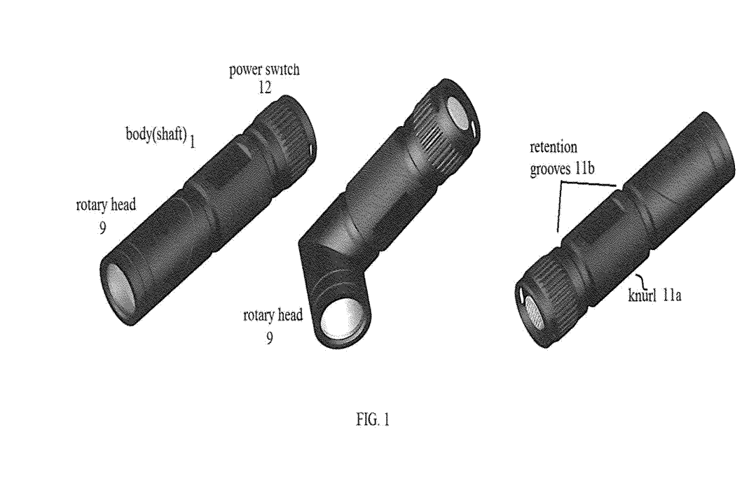

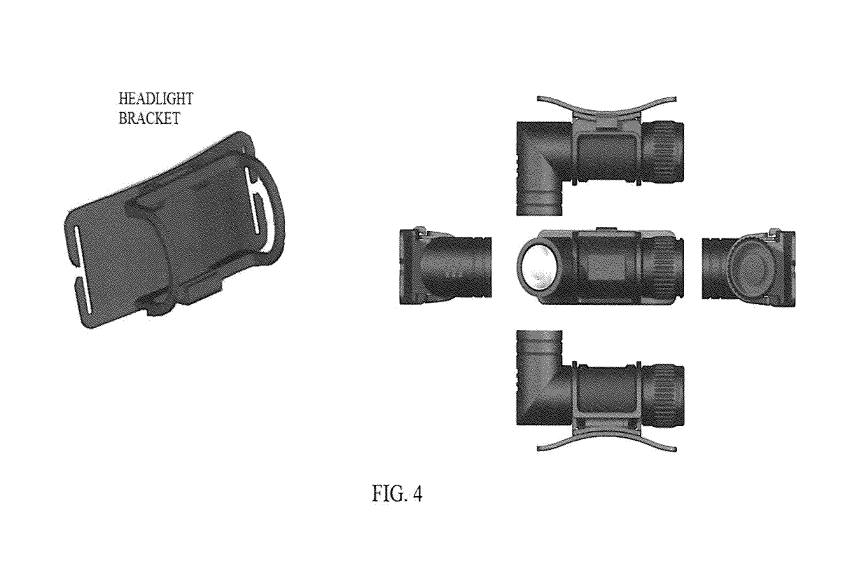

FIG. 1 is a complete view of the present invention showing the main parts that make up this flashlight headlamp. The first component is the rotary head 9, which primary purpose is to provide illumination in addition to having an angle of rotation of ninety degree around the axis. This feature provides the end user multiple angles of illumination without having to change positions or moving position of the flashlight device. As part of the main body, there is also an anti-slip feature called the knurl 11a. The main body (shaft) 1 body contains a knurl lie feature which surrounds the main body. This knurl 11a provides a secure and comfortable grip to the user when handling, preventing the tool from subsiding from the user's hand. The knurl feature is described in other prior arts and will not be elaborated further. The main body also has a secondary retention features refer on FIG. 1 as retention grooves 11b located at opposite ends of the main body (shaft) 1. The purpose of these grooves 11b are to provide a hands-free operation while working. The preferred method of hands free operation is through a head band bracket as shown on FIG. 4. Additionally, this device is powered by internal user replaceable batteries and activated when the power switch 12 is closed.

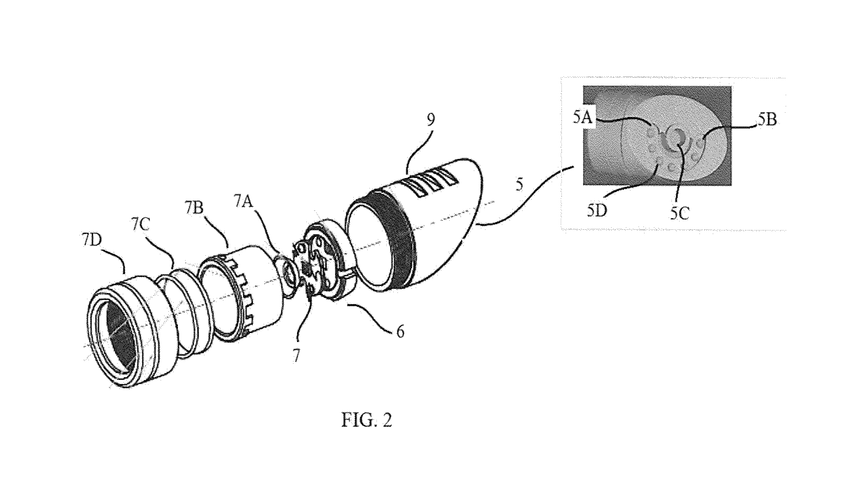

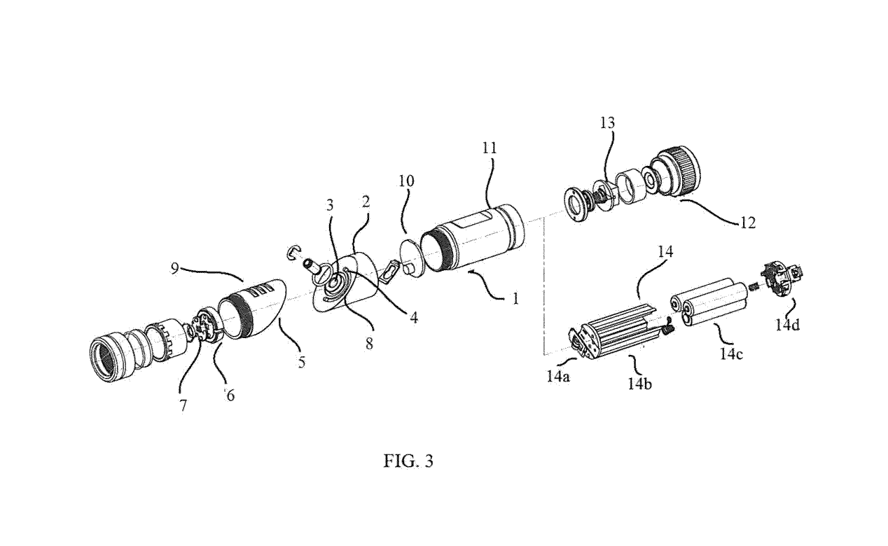

FIG. 2 is an exploded view of the rotary head 9 features and components. The rotary head 9 consist of a high power light emitting diode 7 used as the main lamp for illumination. The light emitting diode lamp contains around its base a rubber washer 7a. This particular washer provides a seal around the base of the lamp to prevent any light from escaping around that area. Once the lamp is powered, the light enters and exits the reflector 7b sending the light out through the front bezel and lens 7d to the outside world. The front bezel and lens 7d are mechanically couple to the rotary head 9 by a threading feature. Additional features are depicted in the rear area of the rotary head 9. These features provide a coupling mechanism to the main body. First, the mating guide stud 5c located in the rear center of the rotary head 9, main purpose is to mechanically align and couple the rotary head 9 with the main body (shaft) 1 as shown in FIG. 1. The mating stud 5c being plastic, protruding with a certain length, width and height is designed to fit inside the rotating guide 3 receptacle shown on FIG. 3 item number 3. Once the rotary head 9 is aligned and couple with the main body (shaft) 1, the rotary functionality of the rotary head 9 is further expanded by the rotating guide 5d and the first position 5a feature and the second position 5b feature located in the rear adjacent to the mating guide 5c. The rotating guide 5 is a feature with a certain depth and a certain groove width that accommodates the rotary stopper 4 on FIG. 3. The utility of the rotating guide 5 is to allow the rotary head 9 to rotate clockwise and counter clockwise on its on axis with a smooth transition between first position 5a, and second position 5b until a full stop is encountered. The described invention achieves complete stops at zero degree and ninety degree angles when the rotary stopper 4 FIG. 3 collides with the wail of the rotating guide 5d at either first or second position. The next sections of this particular embodiment are composed of the mating head 2 and the shaft 1 as shown in FIG. 3, which in conjunction forms the main body in which encapsulates the electrical components of such invention. The shaft 1 has several utility features that collaborate with the invention.

FIG. 3 is an exploded view of the present invention showing all the major electrical and mechanical components that make up the tool. The rotary head 9 was initially described in FIG. 1 and further elaborated on FIG. 2. Additionally, on FIG. 3 the rotary head 9 will be described as a complete assembly part. The rotary head 9 is coupled to the main body (shaft 1) through the mating head 2. There are several mechanical features on the mating head 2 that provide a secure press fit locking mechanism and also the rotating feature for this tool. There is a half circle track 8 that provides a smooth rotation for the rotary head 9, in addition to providing the stopping 4 mechanism at each end. The main body (shaft) 1 includes a printed wiring board 10 that provides an electrical connection between the battery assembly 14 and the main lamp 7 located in the rotary head 9. The printed wiring board 10 also contains a driving circuit that provides the appropriate voltage potential and current level to power the main led 7. The energy source for this flashlight tool is provided by three user replaceable “AAA” 14c battery size that are inserted in the battery housing 14b and are inserted inside the cavity of the main body (shaft) 1. The battery housing also contains a printed wiring board that provides an electrical connection between the main power switch 13 and the rest of the circuit. The power switch 13 is enclosed inside a metal cap with a threaded feature that serves as the securing and coupling mechanism between the switch 13 and the rest of the flashlight tool.

What is claimed is:

1. A flash light headlamp with a high power light emitting diode integrated in a rotary head.

2. A flash light headlamp of claim 1 with retention bands via external bracket as depicted on FIG. 4.

3. A flash light headlamp of claim 1 with a rotary head capable of multi turn around its own axis at a ninety degree angle.

4. A flash light headlamp with a high power light emitting diode integrated in a rotary head capable of turning around its own axis with several angles of rotation between zero and ninety degrees with integrated guide and rotary stopper.
